(19) United States
(12) Patent Application Publication
(10) Pub. No.: US 2006/0183633 A1
(43) Pub. Date: Aug. 17, 2006

(54) Catalyst structure, process for producing same and fuel cell provided with catalyst

(76) Inventor: Tomio Iwasaki, Tsukuba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/352,201

(22) Filed: Feb. 13, 2006

(30) Foreign Application Priority Data
Feb. 14, 2005 (JP) 2005-035370

(51) Int. Cl. B01J 27/22; B01J 21/18; H01M 4/86; H01M 4/90; H01M 4/88

(52) U.S. Cl. 502/177; 502/180; 502/182; 429/44; 502/101

(57) ABSTRACT

An object of the present invention is to provide a catalyst structure of high catalytic activity and fuel cell of high cell output. The catalyst structure of the present invention includes a carrier and catalyst particles formed on the carrier, wherein a difference in lattice constant between the carrier material and the catalyst particle material is 16% or less, preferably 1% to 16%.

### BACKGROUND OF THE INVENTION

The present invention relates to a catalyst structure and fuel cell provided with the catalyst.

Fuel cells have been attracting attention as energy source of the next generation. Recently, fuel cells supplied with a fuel other than hydrogen, which is difficult to handle, have been under development, where methanol has been particularly attracting attention as the fuel. A fuel cell which generates power by direct reaction of methanol on an electrode is referred to as a direct methanol fuel cell (DMFC), and has been studied for applications to various devices, e.g., portable devices. Such a fuel cell is disclosed by, e.g., Japan Society of Applied Physics, Vol. 71, No. 8 (2002), pp. 1005 to 1006. One of the major problems of a DMFC is to improve cell output. As described in the above-mentioned document (Applied Physics), discussion is made on countermeasure wherein effective catalyst area is increased by providing irregularities on the surface to improve catalytic activity.

It is therefore a first object of the present invention to provide a catalyst structure of high catalytic activity. It is a second object to provide a fuel cell of high cell output. It is a third object to provide a catalyst structure stable even at high temperatures.

### SUMMARY OF THE INVENTION

As a result of extensive research to attain the above-mentioned objects, the present inventors have found that a catalyst structure provided with nano-dots formed in contact with a carrier and catalyst particles formed in contact with the nano-dots, wherein a difference in lattice constant between the carrier material and the catalyst particle material is rendered 16% or less, is effective to improve the catalytic activity. It has been also found that this difference is preferably at least 1%, more preferably, 1% to 11%.

The objects of the present invention can be attained, for example, by a catalyst structure having the following structure, and fuel cell provided with the catalyst.

(1) A catalyst structure comprising a carrier, nano-dots formed on the carrier and catalyst particles formed on the nano-dots, wherein a difference in lattice constant between the carrier material and the nano-dot material is 1% to 16%.

(2) A catalyst structure comprising a carrier, nano-dots located adjacent to the carrier, catalyst particles formed on the nano-dots and a coating material formed in contact with the catalyst particles, wherein a difference in lattice constant between the carrier material and the nano-dot material is 1% to 16%.

The present invention can provide a catalyst of high catalytic activity, and a fuel cell of high cell output.

Other objects, features and advantages of the invention will become apparent from the following description of the embodiments of the invention taken in conjunction with the accompanying drawings.

### BRIEF DESCRIPTION OF THE DRAWINGS

FIG. 1 outlines a catalyst structure of the first embodiment of the present invention.

FIG. 2 illustrates a relationship between catalyst WC particle/carrier lattice unconformity and diffusion coefficient ratio.

FIG. 3 illustrates a relationship between catalyst WC particle/carrier lattice unconformity and particle size at 20° C. in the absence of coating material.

FIG. 4 illustrates a relationship between catalyst WC particle/carrier lattice unconformity and particle size at 200° C. in the absence of coating material.

FIG. 5 illustrates a relationship between catalyst particle/electroconductive membrane lattice unconformity and particle size at 200° C. in the presence of coating material composed of carbon nano-horn.

FIG. 6 illustrates a relationship between catalyst WC particle/carrier lattice unconformity and particle size at 200° C. in the presence of coating material composed of B-DNA.

FIG. 7 illustrates a relationship between catalyst WC particle/carrier lattice unconformity and particle size at 20° C. in the presence of coating material composed of carbon nano-horn.

FIG. 8 illustrates a relationship between catalyst WC particle/carrier lattice unconformity and particle size at 20° C. in the presence of coating material composed of B-DNA.

FIG. 9 illustrates a relationship between catalyst MoC particle/carrier lattice unconformity and particle size at 20° C. in the presence of coating material composed of B-DNA.

FIG. 10 outlines a fuel cell as the second embodiment of the present invention.

### EXPLANATION OF REFERENCE NUMERALS

1: Carrier, 2: Nano-dot, 3: Catalyst particle, 4: Coating material, 5: Inclusion particle, 101: Electrolyte membrane, 102: Catalyst-carrying electrode (oxygen electrode), 103: Catalyst-carrying electrode (fuel electrode), 104: Interconnection, 105: Interconnection, 106: Load

### DETAILED DESCRIPTION OF THE INVENTION

The embodiments of the present invention are described in detail by the examples illustrated in the attached drawings. It is to be understood that the present invention is not limited to the embodiments described herein, and does not exclude modifications made based on a known technique or technique known in the future.

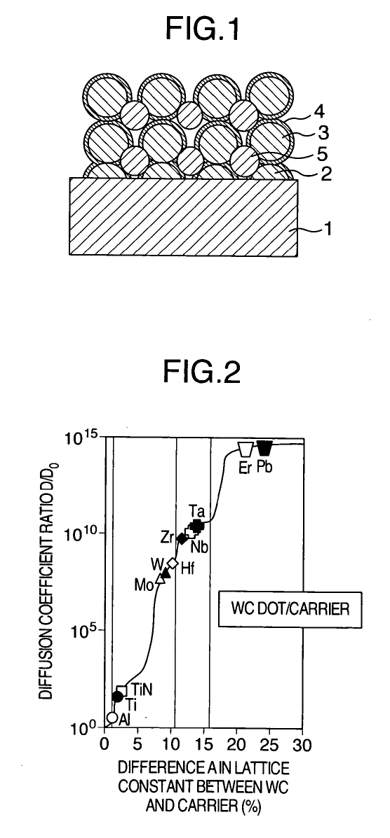

First, FIG. 1 outlines the major parts of a catalyst structure of the first embodiment of the present invention. As illustrated in FIG. 1, the catalyst structure is provided with the carrier 1 which supports the nano-dots 2 coming into contact with the carrier 1, and catalyst particles 3 formed thereon. In FIG. 1, the inclusion particles Sand the coating material 4 are formed around the catalyst particles 3. As method for forming the nano-dots 2, catalyst particles 3 and inclusion particles 5, there may be employed physical deposition or chemical vapor deposition (CVD), for example. The coating material 4 may be formed by coating, physical deposition or chemical vapor deposition (CVD), for example. As for order of forming these components, after a step (1) for forming the nano-dots 4 to a thickness of 0.4 nm to several tens nm or so, a step (2) for forming the inclusion particles 5 to a thickness of 0.4 nm to several tens nm or so, a step (3) for forming the catalyst particles 3 to a thickness of 0.4 nm to several tens nm or so, and step (4) for forming the coating material coating material 4 to a thickness of 0.4 nm to several tens nm or so, in a sequential order of (2), (3), (4), (2), (3), (4) and so on after the step (1). The sequential order may be changed to (4), (2), (3), (4), (2), (3) and so on, or (2), (4), (3), (2), (4), (3) and so on after the step (1). The major component material for the inclusion particles 5 may be the same as that for the carrier 1. The inclusion particles 5 and coating material 4 may be omitted, when they are unnecessary. The nano-dots 2 and catalyst particles 3 are mainly composed of WC, MoC or TaC, which is less expensive than a platinum group metal. The catalyst particles composed of WC may be formed by, e.g., bringing gaseous tungsten hexacarbonyl into contact with the heated carrier 1. The catalyst particles composed of WC may be also formed by, e.g., exposing the carrier to W and C vapors.

In the above catalyst structure, it is preferable to keep a difference in lattice constant between the carrier 1 material and nano-dot 2 material at 16% or less, more preferably not less than 1%, still more preferably 1% to 11%, because the nano-dots 2 and catalyst particles 3 can be sufficiently fine (e.g., 10 nm or less) at room temperature (20° C.) to increase the total surface area of the catalyst particles 3 and hence to improve the catalytic activity functions, when their lattice constants satisfy the above conditions. When the difference is below 1%, the nano-dot constituent atoms are arranged in accordance with the atomic arrangement on the carrier 1 surface, with the result that the nano-dots 2 and catalyst particles 3 are arranged in a film on the carrier 1 surface. It is therefore difficult to increase the total surface area of the catalyst particles 3. When the difference is above 16%, the carrier 1 and nano-dots 2 will become unstable because of excessive lattice unconformity, with the result that the nano-dot constituent atoms diffuse actively to agglomerate each other. This increases nano-dot 2 size, which is accompanied by increased catalyst particle 3 size, and the total surface area of the catalyst particles 3 cannot be increased. When the difference is 16% or less, diffusion of the nano-dots 2 can be controlled to keep the nano-dots 2 and catalyst particles 3 sufficiently fine (e.g., 10 nm or less in size) at room temperature. The difference is preferably controlled at 1% or more. The nano-dots 2 and catalyst particles 3 share a major component to prevent unstable conditions.

In order to explain effects of this embodiment in detail, examples of analysis by use of molecular dynamic simulation are described below. As described in Journal of Applied Physics, Vol. 54, 1983, pp. 4877, the molecular dynamic simulation is a method wherein a force acting on each atom through an interatomic potential is calculated, a Newton's equation of motion is solved based thereon to estimate position of each atom at a given time. In this embodiment, an interaction between different elements is calculated by the above analysis in which charge transfer is taken into consideration to establish the relationship described later.

The major effect of the present invention observed in this embodiment is that the catalyst particles 3 can be sufficiently fine at room temperature by keeping a difference in lattice constant between the carrier 1 material and catalyst particle 3 material at 16% or less, because of controlled diffusion of the catalyst particles 3, as discussed above. This effect can be demonstrated by calculating diffusion coefficient of the catalyst particles 3 in the vicinity of the interface with the carrier 1 to analyze its dependence on lattice unconformity. Application of the molecular dynamic simulation to calculation of diffusion coefficient is discussed in, e.g., Physical Review B, Vol. 29, 1984, pp. 5367 to 5369.

First, simulation is made for a catalyst structure wherein WC is used as materials for nano-dots 2 and catalyst particles 3 without using the coating material 4. The results are shown in FIG. 2, wherein the horizontal axis indicates relative difference A between lattice constant of the nano-dots 2 formed and lattice constant a of the carrier 1, and the longitudinal axis indicates calculated diffusion coefficient D of the catalyst particles 2 in the interface with the carrier 1. Here, the lattice constant a means distance between the nearest atoms. In FIG. 2, D₀ denotes diffusion coefficient of W wherein both the nano-dots 2 and carrier 1 are composed of WC.

In this embodiment, it is preferable to use WC as one example. However, the above-described nano-dots and catalyst particles may be mainly composed of MoC or TaC, which has a lattice constant similar to that of WC and hence basically similar properties. The following description is made with WC taken as an example for the nano-dots and catalyst particles by referring to the figures, while omitting description of MoC and TaC.

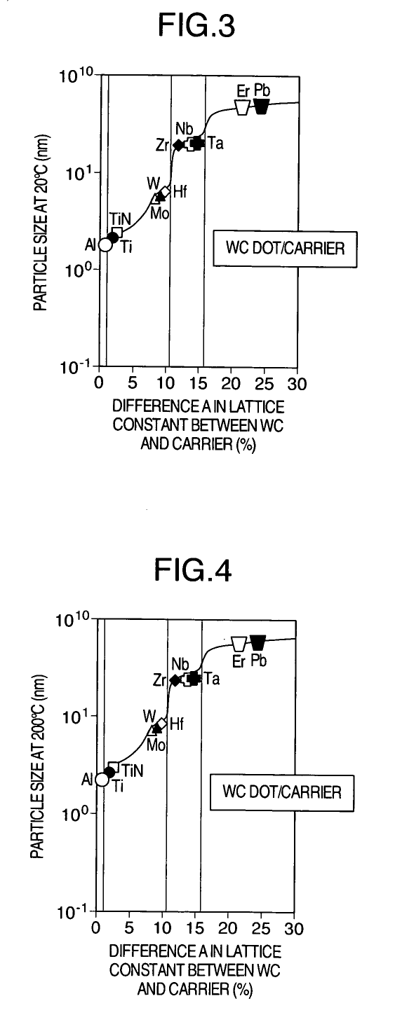

The simulation results shown in FIG. 2 indicate that the nano-dots have a higher diffusion coefficient, more agglomerating each other to grow, as they have a larger difference in lattice constant. As shown, Al, Ti and TiN have a lower diffusion coefficient, and W, Mo, Hf, Er and Pb have a higher coefficient in an ascending order, Pb having the highest. FIG. 3 shows the simulation results with respect to particle size. The results are very similar to those shown in FIG. 2, indicating that the particles have a larger size in the high diffusion coefficient region. It is particularly noted that the diffusion coefficient shown in FIG. 2 significantly increases as the lattice constant difference exceeds 16%. Therefore, the difference is set at 16% or less. It is also found that the particle size shown in FIG. 3 also notably increases at a difference above 16%. At a difference below 1%, it is observed that the particles are arranged in a film, although the particle size is not shown in FIG. 3. Therefore, the difference is preferably 1% or more. Thus, the difference is preferably 1% to 16% in order to increase the total surface area of the catalyst particle. The difference is preferably 11% or less in order to sufficiently decrease the particle size (e.g., to 5 nm or less) as indicated in FIG. 3.

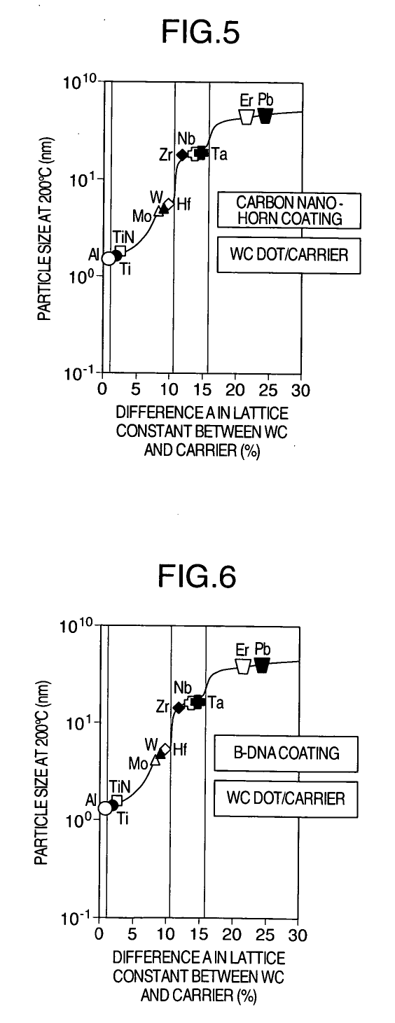

FIG. 4 shows the particle size at 200° C., which is larger at the same lattice constant difference than the catalyst particle size at room temperature shown in FIG. 3. On the other hand, FIG. 5 shows the simulation results at 200° C. wherein a coating material composed of carbon nano-horn is used. Comparing the results shown in FIG. 5 with those shown in FIG. 4 which gives the results in the absence of coating material, the particle size is reduced by about 20% to 30% in FIG. 5. It is thus considered that the coating material composed of carbon nano-horn works to prevent particle growth at high temperature.

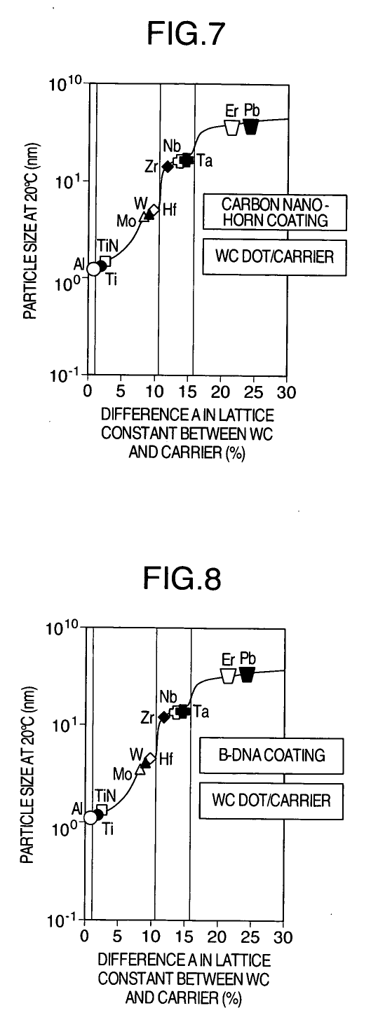

FIG. 6 shows the simulated particle size at 200° C. wherein a coating material composed of B-DNA is used. Comparing the results shown in FIG. 6 with those shown in FIG. 5 which gives the results with carbon nano-horn, the size with B-DNA is reduced by about 20% to 30% in FIG. 6. It is thus considered that B-DNA works to prevent particle growth more efficiently than carbon nano-horn. FIGS. 7 and 8 show the simulation results of particle size at 20° C., which correspond to those shown in FIGS. 5 and 6, respectively. The particle sizes at 20° C. are close to those at 200° C. shown in FIGS. 5 and 6. Thus, it is considered that the coating material composed of carbon nano-horn or B-DNA has an effect of reducing particle size, irrespective of temperature.

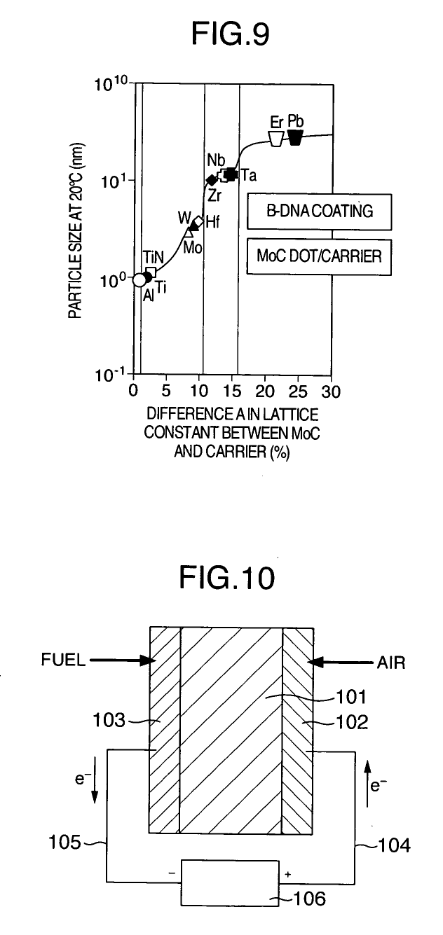

The above embodiment describes the catalyst structure with WC used for the nano-dots and catalyst particles. However, WC may be replaced by TaC or MoC. It can be demonstrated by simulation that TaC or MoC attains similar effect. For example, FIG. 9 shows the simulation results with MoC used for the nano-dots and catalyst particles and with B-DNA for the coating material, indicating the particle size at 20° C. The results are almost similar to those shown in FIG. 8. Thus, it is found that WC can be replaced by MoC to attain the effect of stably reducing the particle size.

Next, FIG. 10 outlines a fuel cell structure as the second embodiment of the present invention. As illustrated, the fuel cell of this embodiment has a structure provided with the electrolyte membrane 101 coated with the catalyst-supporting electrodes 102 and 103 on each side, to which the load 106 is connected by the interconnections 104 and 105. Methanol, for example, may be used as the fuel. The electrode 102 works as an oxygen electrode and the electrode 103 as a fuel electrode. The catalyst for the oxygen electrode 102 is preferably composed of catalyst particles which promote reduction of oxygen, e.g., Pd or Pd alloy. The fuel electrode 103 preferably has a catalyst structure, e.g., that described in the first embodiment. For example, the catalyst particles and nano-dots for the fuel electrode 103 are composed of WC or MoC particles supported by the electrode. As a major component for a carrier of electrode, there is preferably used one selected from the group consisting of Al, Ti, TiN, W, Mo and Hf. Particularly preferably, the carrier of electrode contains at least one selected from the group consisting of Al, Ti and TiN. Such combination can effectively reduce the lattice constant difference and make the particles sufficiently fine. The fuel cell of this embodiment has a high cell output by virtue of the improved catalytic activity functions produced by the effect described in the first embodiment. Moreover, Al, Ti, TiN, W, Mo or Hf used as the major component element for the carrier attains an advantage of being stably connected to a proton-conducting polymer used for the electrolyte membrane 101.

As described above, the present invention is useful as a catalyst for fuel cells and the like.

It should be further understood by those skilled in the art that although the foregoing description has been made on embodiments of the invention, the invention is not limited thereto and various changes and modifications may be made without departing from the spirit of the invention and the scope of the appended claims.

1. A catalyst structure comprising a carrier, nano-dots formed on the carrier and catalyst particles formed on the nano-dots, wherein a difference in lattice constant between the carrier material and nano-dot material is 1% to 16%.

2. A catalyst structure comprising a carrier, nano-size dots located adjacent to the carrier, catalyst particles formed on the nano-dots and a coating material formed in contact with the catalyst particles, wherein a difference in lattice constant between the carrier material and nano-dot material is 16% or less.

3. The catalyst structure according to claim 1, wherein the nano-dots and catalyst particles are composed of a high-melting metal carbide as the major component.

4. The catalyst structure according to claim 1, wherein the nano-dots and catalyst particles are composed of one of WC, MoC and TaC as the major component.

5. The catalyst structure according to claim 1, wherein the carrier is composed of one selected from the group consisting of Al, Ti, TiN, W, Mo and Hf as the major component element.

6. The catalyst structure according to claim 2, wherein
the nano-dots and catalyst particles are composed of one of WC, MoC and TaC as the major component and have a size of 2.6 nm to 4.2 nm,
the carrier is composed of one selected from the group consisting of Al, Ti, TiN, W, Mo and Hf as the major component element, and
the coating material is composed of DNA as the major component.

7. The catalyst structure according to claim 2, wherein
the nano-dots and the catalyst particles are composed of a high-melting metal carbide as the major component,
the carrier is composed of one selected from the group consisting of Al, Ti, TiN, W, Mo and Hf as the major component element, and
the coating material is composed of carbon nano-horn as the major component.

8. The catalyst structure according to claim 2, wherein
the nano-dots and the catalyst particles are composed of one of WC, MoC and TaC as the major component,
the carrier is composed of one selected from the group consisting of Al, Ti, TiN, W, Mo and Hf as the major component, and
the coating material is composed of carbon nano-horn as the major component.

9. A fuel cell comprising a fuel electrode, an oxygen electrode and an electrolytic membrane placed between the fuel electrode and the oxygen electrode, wherein the oxygen electrode contains a catalyst structure according to claim 1.

10. A fuel cell comprising an electrolytic membrane, a fuel electrode placed adjacent to one side of the electrolytic membrane and an oxygen electrode placed adjacent to the other side of the electrolytic membrane, wherein
the fuel electrode is supplied with a fuel containing alcohol as a raw material, and
the oxygen electrode contains a catalyst structure according to claim 2.

11. A method for producing a catalyst structure, comprising
a step for preparing a carrier,
a step for forming nano-dots on the carrier by physical deposition or chemical vapor deposition (CVD), the nano-dots being made of a material having a lattice constant differing from that of the carrier by 1% to 16%, and
a step for forming a catalyst particle on each of the nano-dots.

12. The method according to claim 11, wherein the nano-dots and the catalyst particles are composed of a high-melting metal carbide as the major component.

13. The method according to claim 11, wherein the nano-dots and the catalyst particles are composed of one of WC, MoC and TaC as the major component.

14. The method according to claim 11, wherein the carrier is composed of one selected from the group consisting of Al, Ti, TiN, W, Mo and Hf as the major component.

15. A method for producing a fuel cell comprising a fuel electrode, an oxygen electrode and an electrolytic membrane placed between the fuel electrode and the oxygen electrode, the method comprising
a step for preparing the oxygen electrode,
a step for forming nano-dots on the carrier by physical deposition or chemical vapor deposition (CVD), the nano-dots being composed of a material having a lattice constant differing from that of the carrier by 1% to 16%, and
a step for forming a catalyst particle on each of the nano-dots.

16. The method according to claim 11, wherein the catalyst particle is formed on each of the nano-dots by physical deposition or chemical vapor deposition (CVD).
